(19) United States
(12) Patent Application Publication
(10) Pub. No.: US 2017/0231214 A1
(43) Pub. Date: Aug. 17, 2017

(54) SYSTEM FOR TRAPPING PESTS AND METHOD OF MANAGING SAME

(71) Applicant: Sensorodit Limited, Wellington (NZ)

(72) Inventors: Alexander VAISBLAT, Wellington (NZ); Michael John WILLOUGHBY, Wellington (NZ)

(21) Appl. No.: 15/431,855

(22) Filed: Feb. 14, 2017

Related U.S. Application Data
(60) Provisional application No. 62/295,173, filed on Feb. 15, 2016.

(51) Int. Cl. A01M 23/08; H04W 4/02; G08B 21/18; A01M 31/00; E04B 1/72

(52) U.S. Cl. CPC A01M 23/08; A01M 31/008; A01M 31/002; E04B 1/72; G08B 21/18; H04W 4/02

(57) ABSTRACT

A system for trapping pests includes a central managing unit and a plurality of pest traps in active communication with the central managing unit. Each pest trap includes one or more detachable cartridges, one or more base elements adapted to releasably hold the one or more detachable cartridges, each base element comprises one or more sensors; each of the one or more sensors is configured to sense a presence of a pest in one of the detachable cartridges, a communication unit and a trap controller configured to receive signals from the one or more sensors and send indications to the central managing unit via the communication unit. The central managing unit is configured to: receive from at least one of the plurality of pest traps an indication that a pest is trapped in at least one detachable cartridge and send an alert to a user device based on receipt of the indication.

### BACKGROUND OF THE INVENTION

Controlling pests' populations, such as rodents and snakes, becomes a major problem in populated areas. Municipalities spend both money and manpower to control pests' populations. The current methods include manual inspection of traps placed in required places, such as schools, hospitals, warehouses and the like. The inspectors must visually inspect each trap to see if a pest was already trapped. Currently, there is no system that may allow the inspectors to know if a pest was trapped in a particular trap, prior to reaching and inspecting the tarp.

### SUMMARY OF THE INVENTION

Aspects of the invention may be related to a system for trapping pests. The system may include a central managing unit and a plurality of pest traps in active communication with the central managing unit, each of the plurality of pest traps. In some embodiments, each pest trap may include one or more detachable cartridges, one or more base elements adapted to releasably hold the one or more detachable cartridges, each base element comprises one or more sensors; each of the one or more sensors is configured to sense a presence of a pest in one of the detachable cartridges, a communication unit and a trap controller configured to receive signals from the one or more sensors and send indications to the central managing unit via the communication unit. In some embodiments, the central managing unit may be configured to: receive from at least one of the plurality of pest traps an indication that a pest is trapped in at least one detachable cartridge and send an alert to a user device based on receipt of the indication.

Additional aspects of the invention may be related to a method of managing a system for trapping pests. The method may include: receiving a location of the at least one of a plurality of pest traps and receiving localization information of one or more user devices. In some embodiments, sending the alert to the user device is also based on the location of the at least one of a plurality of pest traps the localization information.

Additional aspects of the invention may be related to a method of deploying pest traps. The method may include receiving by a processor, from one or more sensors configured to sense a presence of a pest in a plurality of pest traps, during a predetermined period of time indications related to pests trapped in a plurality of pest traps and the location of each pest trap, receiving, by the processor, from one or more sensor for sensing environmental condition, during the predetermined period of time signals related to environmental conditions at the surroundings of the plurality of pest traps and determining, by the processor, pests expected behavior based on the received indications and signals.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a system for trapping pests according to some embodiments of the invention;

FIG. 2A is an illustration of a pest trap according to some embodiments of the invention;

FIGS. 2B-2E are illustrations of different configurations of pest traps according to some embodiments of the invention;

FIGS. 3A and 3B are illustrations of a detachable cartridge according to some embodiments of the invention;

FIGS. 3C and 3D are illustrations of a detachable cartridge with an open and closed door according to some embodiments of the invention;

FIG. 4 is a flowchart of a method of managing a system for trapping pests according to some embodiments of the invention;

FIG. 5 is a flowchart of a method of deploying pest traps according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some embodiments of the invention may be directed to a system for trapping pests (e.g., rodents, reptiles, or the like) and methods for managing such system. According to some embodiments, the system may include a plurality of pest traps and a central managing unit to manage the plurality of pest traps. The pest traps may be placed at various desired locations for trapping the pests, for example, at gardens, on trees, in basements, warehouses or the like. Each pest trap may include one or more detachable cartridges for trapping pests. The detachable cartridges may be attachable and detachable from a base holding the detachable cartridges. Each detachable cartridge may be associated with a sensor configured to sense a presence of a pest in the cartridge. The sensor may be held by the base and may partially penetrate to the internal volume of the cartridge. The pest trap may further include a controller for receiving an indication that a pest was trapped at one or more of the cartridges and sending the indication to the central managing unit via a communication unit.

The central managing unit may be configured to receive indication that a pest is trapped in at least one detachable cartridge and send an alert to a user device based on receipt of the indication. The central managing unit may further receive the location of each pest trap (e.g., a certain address, geographic coordinates or the like) and localization information of a user device (e.g., coordinates from a Global Positioning System (GPS) of a smart phone or another portable computing device) and may send the user (e.g., a pest controller) an alert to empty the detachable cartridge. The central managing unit may further receive additional indications and signal from the pest traps. For example, the pest traps may include additional sensors, such as humidity sensors, thermometers, or other sensors for sensing environmental conditions, and the central managing unit may be configured to process the received indications and to determine pest expected behavior.

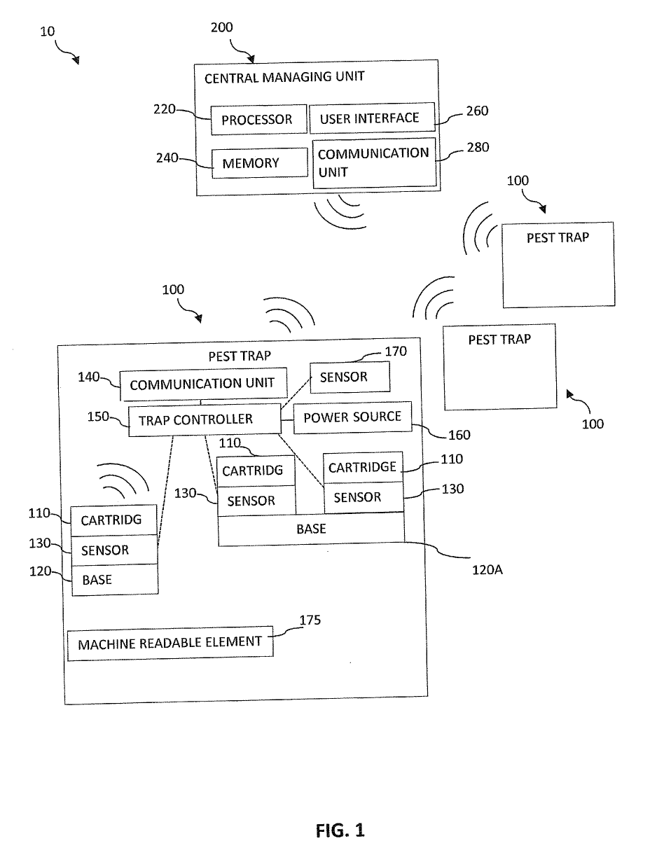

Reference is made to FIG. 1, which is a block diagram of a system for trapping pests according to some embodiments of the invention. System 10 may include a central managing unit 200 and a plurality of pest traps 100 in active communication with central managing unit 200. Central managing unit 200 may include a processor 220 a memory 240, user interface 260 and a communication unit 280. In some embodiments, central managing unit 200 may be remotely located from pest traps 100. For example, central managing unit 200 may be located at the headquarters of the pest controllers and pest traps 100 may each be located at areas that may have a potential rodent infestation.

Processor 220 may be, for example, a central processing unit (CPU), a chip, a cloud computing service or any suitable computing or computational device. Memory 240 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 240 may be or may include a plurality of, possibly different memory units. Memory 240 may be remotely located on a cloud computing service.

Central managing unit 200 may be included in a desktop computer, laptop computer, a tablet, a mainframe computer or the like. Processor 220 may be configured to carry out methods according to some embodiments of the present invention, for example, executing instructions stored in a memory such as memory 240 to control and manage a plurality of pest traps 100. Memory 240 may store any executable code, e.g., an application, a program, a process, task or script. The executable code may include codes for controlling and managing a system for trapping pests or any other codes or instruction for executing methods according to some embodiments of the present invention. The executable code may be executed by processor 220 possibly under control of an operating system.

User interface 260 may be or may include a screen (e.g., a monitor, a display, a CRT, etc.), a pointing device (e.g., a mouse, a touch screen or a pad) and an audio device. User interface 260 may include or be associated with other input devices such as, a keyboard. User interface 260 may include audio device such as one or more speakers, earphones and/or any other suitable audio devices. It will be recognized that any suitable number of output devices may be included in user interface 260. Any applicable input/output (I/O) devices may be connected to central unit 200. For example, a wired or wireless network interface card (NIC), a modem, printer or facsimile machine, a universal serial bus (USB) device or external hard drive may be included in user interface 260.

Central managing unit may further include communication unit 280. Communication device 280 may be in active communication with each pest trap 100 included in device 10. Communication unit 280 may include any transceiver known in the art to wirelessly communicate between two points, for example, communication unit 280 may include: GSM modem, radio transceiver, Wi-Fi communication device, Bluetooth communication device, or the like.

In some embodiments, each pest trap 100 may include one or more detachable cartridges 110 and one or more base elements 120 adapted to releasably hold one or more detachable cartridges 110. Each base element 120 may include one or more sensors 130 that may be configured to sense a presence of a pest in one of detachable cartridges 110. Pest trap 100 may further include communication unit 140 and a trap controller 150 that may be configured to receive signals from one or more sensors 130 and send indications that a pest was trapped in cartridge 110 to central managing unit 200 via communication unit 140. In some embodiments, pest trap 100 may further include one or more additional sensors 170. Sensors 170 may be configured to sense environmental condition of the surroundings of pest trap 100. In some embodiments, communication unit 140 and sensors 130 and 170 may communicate with trap controller 150 via wired or wireless communication, using any known method or communication protocol. In some embodiments, pest trap 100 may further include a power source 160 (e.g., a battery) for supplying power to the electronic or electromechanical components of trap 100. In some embodiments, a single power source 160 may power all the components of a single trap 100. In some embodiments, each base 120 or 120A may include a separate power source 160.

For example, sensor 170 may be or may include a thermometer, a humidity sensor a barometer or the like. One or more sensors 170 may send signals to trap controller 150. In some embodiments, sensor 130 and/or sensor 170 may include: a sound based sensor, an ultrasound based sensor, heat based sensor, vibration based sensor, movement based sensor, radio frequency based sensor, light based sensor, laser based sensor and/or weighing scale. In some embodiments, pest trap 100 may further include a machine readable element 175, such as RFID, a bar code and the like. In some embodiments, information read from machine readable element 175 may be associated or may include the ID of pest trap 100, the type of bait placed in pest trap 100, the type of pest trap 100 and the like. In some embodiments, machine readable element 175 may be located at the end of cartridge 110 near the bait, as will be illustrated and discussed below.

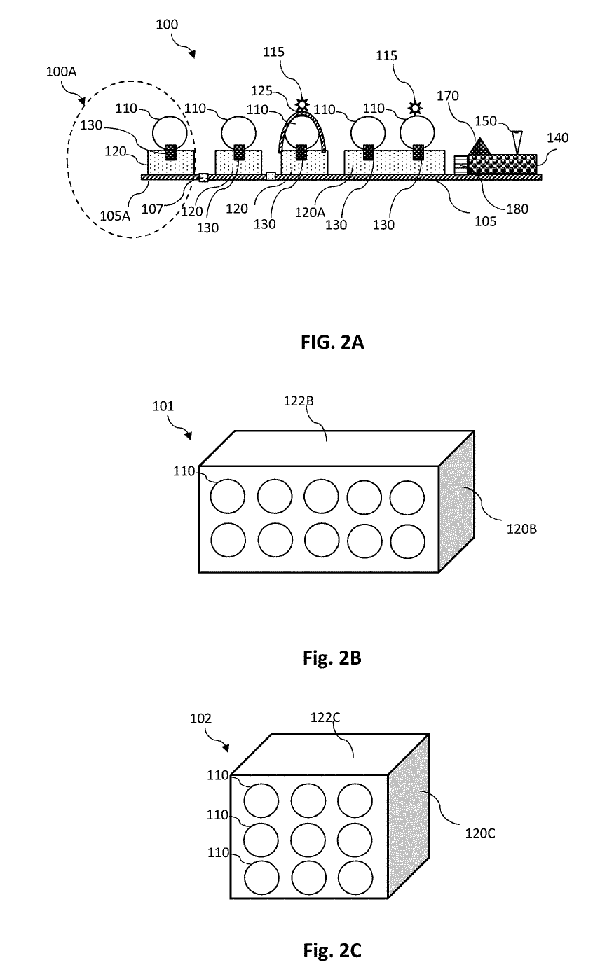

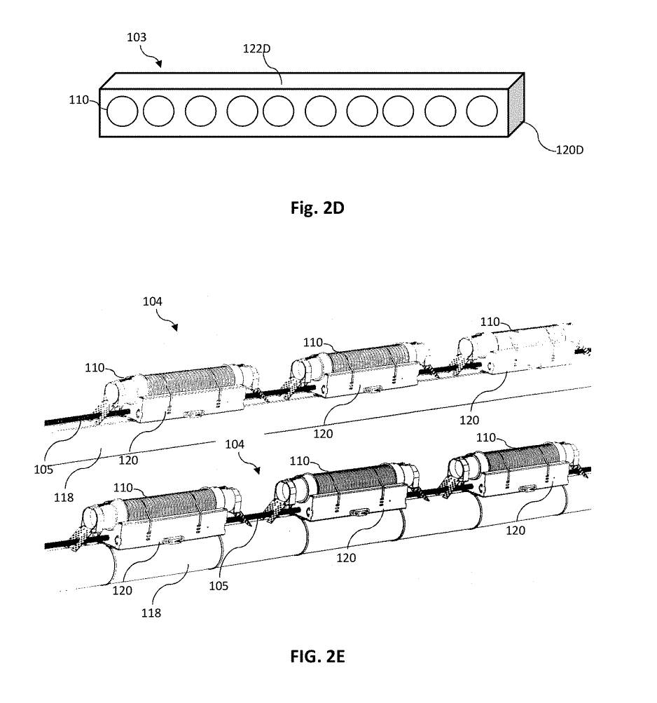

Reference is made to FIG. 2A, which is a schematic illustration of a cross sectional view of a pest trap according to some embodiments of the invention. Pest trap 100 may include one or more detachable cartridges 110 and bases 120 and 120A. Base 120 may be configured to hold a single detachable cartridge 110, while base 120A may be configured to hold two or more detachable cartridges 110. Bases 120 and/or 120A may include any substrate that allows mounting or holding detachable cartridge 110. For example, bases 120 and/or 120A may include high density polymeric foam or any other suitable material. An exemplary bases 120 and/or 120A may further include a plastic holder glued to the high density polymeric foam substrate. Another exemplary base 120 and/or 120A may include a folded metallic sheet (e.g., 1.2 mm thick aluminum sheet) folded to hold one or more cartridges 110. The disclosed bases are given as examples only and the invention as a whole is not limited to a specific base design. Bases 120 and/or 120A may take any shape and may include any material or combination of materials that may allow bases 120 and/or 120A to hold one or more cartridges 110 and to accommodate the required components (e.g. sensors, connectors, plugs, etc.) as described above and herein.

In some embodiments, each base 120 or 120A may include one or more holding mechanisms 125. Holding mechanisms 125 may be configured to allow attaching and detaching of detachable cartridge 110 from base 120. Holding mechanisms 125 may include strips (e.g., plastic, elastic, metallic or the like) and any type of buckle, clasp, connector, or any suitable mechanism for attaching and detaching of detachable cartridge 110. In some embodiments, attaching and detaching of detachable cartridge 110 may be performed by a user using a single hand.

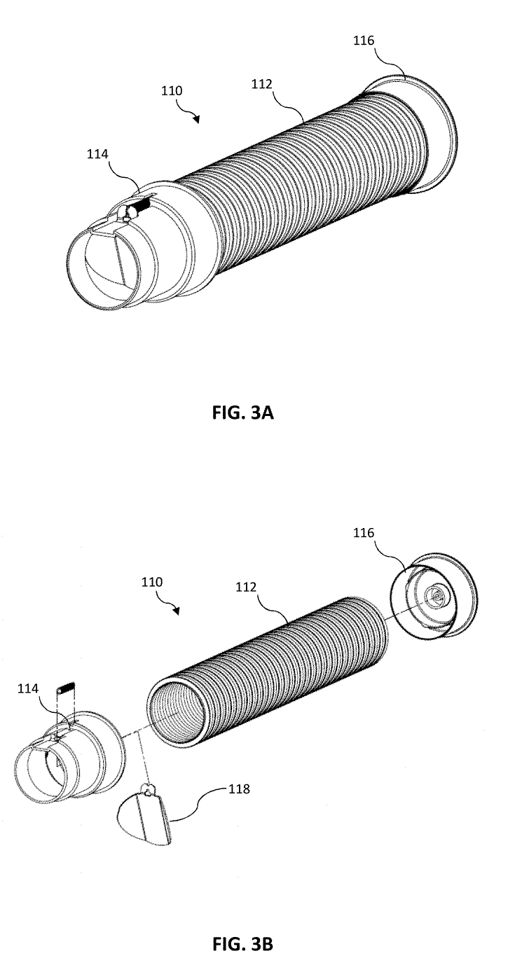

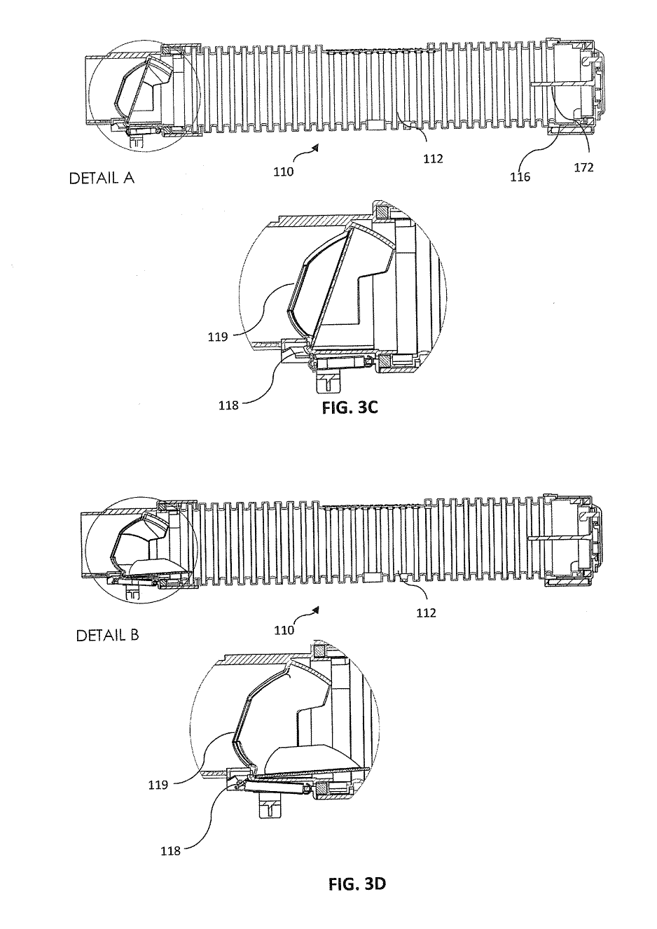

In some embodiments, bases 120 and/or 120A may hold sensor 130. Sensor 130 may be or may include a piezoelectric device or any other electronic component configured to sense the presence of a pest in the cartridge. For example, sensor 130 may sense vibrations in cartridge 110 caused by a rodent climbing into cartridge 110 and/or sensor 130 may sense an opening of cartridge 110 door (illustrated in FIGS. 3A and 3B). An exemplary electronic components of sensor 130 may be embedded in a polymeric (or any other dielectric material) housing and inserted or attached to base 120 (e.g., to the polymeric foam, folded aluminum sheet and the like). In some embodiments, at least a portion of sensor 130 may penetrate or protrude into an internal volume defined by cartridge 110, via an opening in cartridge 110 in order to sense the presence of a pest (e.g., rodent or a snake) in cartridge 110.

In some embodiments, each cartridge 110 may be associate with an indication lamp 115 that may be lighten up when a pest is trapped in cartridge 110. Controller 140 may cause lamp 115 to be lighten up when a signal is received from sensor 130 that a pest was trapped. Lamp 115 may indicate for a pest controller in which of cartridges 110 a pest was trapped.

In some embodiments, each base 120 or 120A may be or may include inter-connectable substrates each substrate comprises one of the at least one holding mechanisms 125 for holding cartridge 110. Bases 120 and 120A may be interconnected by connector 105. According to some embodiments, connector 105 may be configured to both mechanically connect bases 120 and 120A and transfer electricity and communication signals between sensors 130 and trap controller 150. It should be appreciated that one or more of the communication, power supply and mechanical connection may be done via separate connector(s). According to one embodiment, connector 105 may include stainless steel rope that may be fixed to both side of base 120 or 120A. Connector 105 may include a plurality of chain connectors 105A connected to each other by plugs 107. Connector 105 may be flexible and may allow rapping pest trap 100 around objects such as trees, lamp posts or the like. According to some embodiments, plugs 107 may be configured to both mechanically connect connectors 105A and to transfer electricity and communication signals. Each connector 105A may be connected to one or more bases 120 or 120A as to form a pest trap element 100A.

Pest trap element 100A may include one or more connectors 105A at least one plug 107, at least one base 120, at least one sensor 130 and at least one detachable cartridge 110. In some embodiments, pest trap 100 may include a plurality of pest trap elements 100A connected to each other via plugs 107.

Connector 105 may electrically connect trap controller 150 to sensors 130. Controller 150 may be or may include a memory and a processing unit, a chip or any suitable computing or computational device that may execute codes or instructions saved in the memory, for example, instructions to receive signals from one or more sensors 130 and send indications to central managing unit 200 via the communication unit 140. Pest controller 150 may further be configured to send signals related to environmental conditions at the surrounding of pest trap 100, received from one or more sensors 170.

Communication unit 140 may be or may include any transceiver known in the art to wirelessly communicate trap controller 150 and central managing unit 200, for example, communication unit 140 may include: GSM modem, radio transceiver, Wi-Fi communication device, Bluetooth communication device, or the like.

According to some embodiments, pest trap 100 may further include a power source 180. Power source 180 may be configured to provide power to all the electronic components of pest trap 100. For example, power source 180 may provide power to one or more sensors 130, communication unit 140, one or more sensors 170 and trap controller 150. According to some embodiments, power from power source 180 may be supplied to all components of system 100 via one or more connectors 105A or via a separate power supply cable (not shown).

Reference is made to FIGS. 2B-2D which are illustrations of exemplary pest traps according to some embodiments of the invention. A pest trap 101 illustrated in FIG. 2B may include a base or housing 120B configured to hold an array of cartridges 110. In the exemplary embodiment of FIG. 2B two rows of five cartridges 110 are illustrated. Each cartridge 110 may include substantially the same elements and may be detachable and replaceable in the same why as discussed above. Base (e.g., housing) 120B may include a door 122B configured to allow simple access for replacing cartridges 110. Door 122B may slide out, tilt off, or otherwise open to allow access to the internal volume of base 120B. Door 122b may include the entire side panel of base 120B or a portion of the side panel. Trap 101 may further include at least one of: one or more sensors 130, communication unit 140, trap controller 150, power source 160, and any other component included in pest trap 100 disclosed above.

Pest traps 102 and 103 illustrated in FIGS. 2C and 2D are additional exemplary configurations of pest trap 101 and include substantially the same elements of pest trap 101. Cartridges 110 may be arranged in three by three array illustrated in FIG. 2C and a “train”-like array illustrated in FIG. 2D. Both traps 102 and 103 may include a base (or housing) 120C or 120D, each having a door 122C or 122D for allowing easy detaching and replacing of cartridges 110.

Reference is made to FIG. 2E, which is an illustration of two additional configurations of pest traps. A pest trap 104 may include a plurality of cartridges 110 attached to a longitudinal support 118 (e.g., a beam or a pipe as illustrated). Each of cartridges 110 may be attached to a base 120 which in turn may be connected to longitudinal support 118 using any known method. All cartridges 110 and corresponding bases 120 may be connected to each other mechanically and/or electrically by connectors 105. Connectors 105 may connect cartridges 110 to controller 140, communication unit 150, sensor 170 and/or power source 180 (illustrated in FIG. 2A).

Reference is made to FIGS. 3A and 3B, which are illustrations of a detachable cartridge 110 according to some embodiments of the invention. Detachable cartridge 110 may include: a body 112, a first end cap 114 and a second end cap 116. In some embodiments, at least one of the first and second end caps comprises a door mechanism 118 adapted to allow pests to enter cartridge 110. In some embodiments, at least one of first end cap 114, second end cap 116 and body 112, may be reusable (e.g., disposable). In some embodiments, only body 112 may be disposable and may be easily disassembled from first end cap 114 and second end cap 116. For example, body 112 may be made from a recycled polymer and first end cap 114 and second end cap 116 from stainless steel.

An exemplary embodiment of door mechanism 118 may include a tongue shaped galvanized tin (or other metal) that may be spring loaded to be closed. Door mechanism 118 may allow door 119 to slightly open by a few millimeters allowing pests (e.g., rodents) to push through without too much opposition. Door mechanism 118 may be snapped onto the corrugated pipe and disassembled from body 112 for reuse.

In some embodiments, at least one of first and second end caps 114 and 116 may include a bait holder 172 (illustrated in FIG. 3C), bait holder 172 (e.g., a hook) may be projecting into an internal space of the body. The bait holder may be for hanging a bait to attract the pest into the cartridge. The end cap also has provision for a concave shaped cup to fit into it and provide a way to dispense liquid bait. In some embodiments, machine readable element 175, such as an RFID tag, may be attached to the end of cap 116 in proximity to bait holder 172. Upon touching the bait by the pest, sensor 130 or controller 150 may activate machine readable element 175. Machine readable element 175 may include information such as: the type of bait, weight of bait, manufacturer of bait, unique ID of bait and the like.

Body 112 may include a ribbed tube (having any cross section). The ribs in the tub may aid the pest climbing and entering into cartridge 110 more easily. An exemplary detachable cartridge 110 may be 300 mm to 400 mm long having a diameter of 65 mm Other dimensions may be used.

In some embodiments, door mechanism 118 may be remotely controlled by an operator, and first end cap 114 may be configured to remain open even when the presence of a pest has been detected. The pest may be allowed to enter and exit cartridge 110 several times and to get familiar with the trap, before an operator, or controller 140 instruct door mechanism 118 to close first end cap 114 and trap the pest. The controlling of each cartridge 110 in an array of cartridges 110 (e.g., apparatuses 100, 101, 102 and 103) may be done simultaneously or separately for each cartridge 110. The operator may remotely control door mechanism 118, by sending an instruction to controller 140 via communication unit 150. The controller may then control door mechanism 118 to close first end cap 114 and trap the pest. Alternatively, controller 140 may be configured to control door mechanism 118 to close first end cap 114 after detecting presence of a pest in cartridge 110 during a predetermined amount of time, detecting a presence of a pest a predefined number of times etc.

In some embodiments, cartridge 110 may include baffles, such as half-moon baffles, in order to prevent unauthorized users (e.g., children, passersby, etc.) from entering body parts into a cartridge, such as for example putting their arm all the way to the end of the cartridge and touching a bait located in cartridge 110. Cartridge 110 and apparatuses 100, 101, 102 and 103 may include additional safety features for protecting users from being harmed if trying to open or otherwise engage with cartridge 110 and/or the pest trapped in cartridge 110.

Reference is now made to FIGS. 3C and 3D, which illustrate a detachable cartridge with an open and closed door, respectively, according to some embodiments of the invention. Cartridge 110 illustrated in FIGS. 3C and 3D includes door 118 operated by a door mechanism 119. Door mechanism 119 may cause door 118 at the closed position to be shrouded on the inside of the cartridge and not orthogonal to the longitudinal axis of cartridge housing 112, thus making it impossible for the pest to open the door from within.

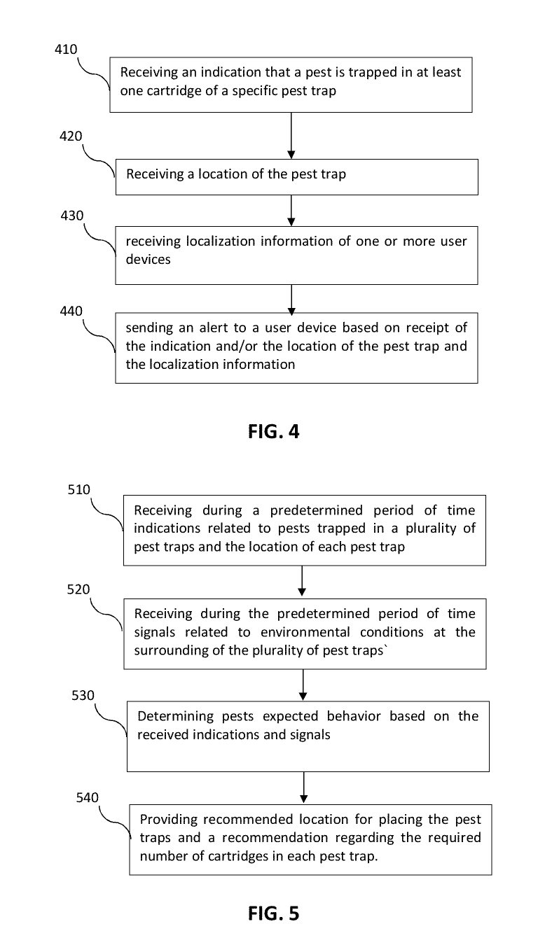

Reference is made to FIG. 4, which is a flowchart of a method of managing a system for trapping pests according to some embodiments of the invention. The embodiments of FIG. 4 may be performed by central managing unit 200 or by any other suitable controller. In operation 410, some embodiments may include receiving an indication that a pest is trapped in at least one cartridge 110 of a specific pest trap 100. When a pest is trapped in cartridge 110 of a specific trap 100 at least one sensor 130 associated with the specific cartridge 110 may send a signal to trap controller 150. Trap controller 150 may send an indication that a pest was trapped in the specific cartridge to central managing unit 200 via communication unit 140.

In operation 420, some embodiments may include receiving a location of the pest trap 100 from which the indication was received. Processor 220 may receive an ID number of the pest trap. The ID number may be sent by pest controller 150 together with the indication that a pest was trapped in this particular pest trap. Processor 220 may then use a lookup table to correlate between the location of the pest trap and the ID number. The location of the pest trap may be initially received from a user device of the user placing the pest trap. For example, the user may use a mobile user device to communicate with managing unit 200 and may send to unit 200 information associating pest trap ID number with the pest trap location. In some embodiments, the user may use a reader (e.g., an RFID reader, a bar code reader, etc.) to read the ID and additional information from machine readable element 175 attached to pest trap 100. Additionally or alternatively, each pest trap may include a localization sensor (e.g., a GPS antenna) that may be connected to pest controller 150. Accordingly, pest controller 150 may send to managing unit 200 localization information (e.g., geographical coordinates) related to the pest trap together with the indication that pest(s) were trapped in one or more of the cartridges.

In operation 430, some embodiments may include receiving localization information of one or more user devices. Managing unit 200 may receive the location of a smartphone (or any other mobile device) of one or more pest controllers, for example, using GPS signals. In operation 440, some embodiments may include sending an alert to the user device based on receipt of the indication. The system may alert at least one user by sending an alert to the user's mobile device that a pest was trapped in a particular pest trap 100. The alert may include, the number of pests trapped in the pest trap and the location of the trap. In some embodiments, central managing unit 200 may be configured to select the user device to which the alert is to be sent based on the location of the user device. Processor 220 may calculate the distance (e.g., traveling distance, or traveling time) between all potential user devices and the particular pest trap, and to select to send the alert to the user device being in the shortest and/or quickest traveling distance/time from the pest trap. In some embodiments, a user (e.g., a pest controller) arriving to the pest trap may see one or more lamps 115 lighten up indicating in which of cartridges 110 a pest was trapped.

In some embodiments, the method may further include monitoring the bait located in the pest trap, for example, using a sensor (e.g., sensor 130 or 170) and/or a machine readable element (e.g., machine readable element 175) such as an RFID tag located in proximity to the bait. The machine readable element may further include information related to the type of bait, weight of bait, manufacturer of bait, unique ID of bait and the like. In some embodiments, the sensor may send an alert to a user-device when bait is consumed and should be replenished.

Some embodiments of central managing unit 200 may include collecting information from the plurality of pest traps 100 over a period of time (e.g., over several weeks, several months, a year or the like). The information may include the location and number of pests trapped and the environmental conditions during the period at which the pests were trapped. Other data may be collected, stored and analyzed by central managing unit 200.

Reference is made to FIG. 5 which is a flowchart of a method of deploying pest traps according to some embodiments of the invention. The embodiments of FIG. 5 may be performed by central managing unit 200 or by any other suitable controller.

In operation 510, some embodiments may include receiving during a predetermined period of time indications related to pests trapped in a plurality of pest traps and the location of each pest trap. Central managing unit 200 may collect over several periodic time intervals (e.g. weeks, months, seasons, years etc.) information that relates to the number of pests trapped and the locations at which the pests were tapped. In some embodiments, the method may include conducting surveillance on the number of pests in an area. In some embodiments, the method may include determining whether pests are present in the area based on the indications related to pests trapped in a plurality of pest traps placed in locations within the area. In some embodiments, central managing unit 200 may compare the number of pests trapped in the area in the predetermined period of time in comparison to historical amount of pests trapped in previous predetermined period of times. If an increase in the number of pests trapped is identified, the central managing unit 200 may send to a user device an alert that the area has an increase in pets' population.

In operation 520, some embodiments may include receiving during the predetermined period of time signals related to environmental conditions at the surroundings of the plurality of pest traps. The signals may be received from one or more sensors 170 associated with each pest trap. The signals may include the temperature and humidity at the surroundings of each pest trap at different hours during the day and/or the temperature and humidity when a pest was trapped in at least one cartridge.

In operation 530, some embodiments may include determining pests expected behavior based on the received indications and signals. Processor 220 may determine based on the received indication at which areas (e.g., of a town) there was a rodent infestation problem during the predetermined period of time and what was the environmental conditions at these areas during the rodent infestation, thus may correlated between changes in the environmental conditions (e.g., raise in temperatures and humidity) to the probability of having a rodent infestation at a particular area. For example, during winter pests may concentrate at warmer areas (e.g. subway ventilation outlets, areas exposed to direct sunlight etc.) while during summer cooler areas may attract more pests, and a different trap deployment may be recommended. Processor 220 may further determine if particular areas are more likely to have rodent infestation than other areas. Processor 220 may further determine specific period (e.g., seasons, months) in year that may be associated with higher pests (e.g., rodents, snakes) activity in a particular area (e.g., a city, a neighborhood, parks, etc.).

In operation 540, some embodiments may include providing recommended location for placing the pest traps. Processor 220 may process past pest behavior, identify areas and periods that are more likely to have pest infestation (e.g. at a given time period), and recommend specific locations within the area for placing pest traps (e.g., pest traps 100). In some embodiments, the method may further include a recommendation regarding the required number of cartridges (e.g., cartridges 110) in each pest trap. Processor 220 may further analyze the amount of pests that were trapped at the specific area during the predetermined time period and may further calculate a prediction of the number of required cartridges in each pest trap for each future corresponding time period (e.g., for every August, for every winter and the like) based on the collected data from previous time periods (e.g., past August, past winter, etc.). The prediction may further be calculated based on external information, such as weather forecast, information from users and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system for trapping pests, comprising:
a central managing unit; and
a plurality of pest traps in active communication with the central managing unit, each of the plurality of pest traps, comprising:
one or more detachable cartridges;
one or more base elements adapted to releasably hold the one or more detachable cartridges, each base element comprises one or more sensors; each of the one or more sensors is configured to sense a presence of a pest in one of the detachable cartridges;
a communication unit; and
a trap controller configured to receive signals from the one or more sensors and send indications to the central managing unit via the communication unit;
wherein the central managing unit is configured to:
receive from at least one of the plurality of pest traps an indication that a pest is trapped in at least one detachable cartridge; and
send an alert to a user device based on receipt of the indication.

2. The system of claim 1, wherein the central managing unit is remotely located from the plurality of pest traps.

3. The system of claim 2, wherein the communication unit of each pest trap is configured to communicate with the central managing unit via wireless communication.

4. The system of claim 1, wherein the central managing unit is configured to:
receive location of each pest trap;
receive localization information of one or more user devices; and
send the alert based on the location of the trap and the localization information of the one or more user devices.

5. The system of claim 4, wherein each pest trap further comprises a localization detector for detecting a location of the trap.

6. The system of claim 4, wherein the location of each trap is received from a user placing the pest trap.

7. The system of claim 1, wherein each detachable cartridge is shaped as a ribbed tube.

8. The system of claim 1, wherein the base comprises one or more holding mechanisms, the one or more holding mechanisms are configured to allow attaching and detaching of the detachable cartridge from the base.

9. The system of claim 1 wherein each cartridge comprises:
a body;
a first end cap; and
a second end cap;
wherein at least one of the first and second end caps comprises a door mechanism adapted to allow pests to enter the cartridge.

10. The system according to claim 9 wherein at least one of the first and second end caps comprise a hook, the hook projecting into an internal space of the body.

11. The system according to claim 9 wherein at least one of the first end cap, the second end cap and the body, is reusable.

12. The system of claim 1 wherein said communication unit is one of a list consisting: GSM modem, radio transceiver, Wi-Fi communication device, and Bluetooth communication device.

13. The system of claim 8 wherein the base comprises inter-connectable substrates, wherein each substrate comprises at least one holding mechanism.

14. The system of claim 1 wherein each pest trap further comprises a power source, wherein the power source is configured to provide power to at least one base element.

15. A method of managing a system for trapping pests, comprising:
receiving from at least one of a plurality of pest traps an indication that a pest is trapped in at least one detachable cartridge included in each pest trap; and
sending an alert to a user device based on receipt of the indication.

16. The method of claim 15, further comprising:
receiving a location of the at least one of a plurality of pest traps; and
receiving localization information of one or more user devices,
wherein sending the alert to the user device is also based on the location of the at least one of a plurality of pest traps the localization information.

17. The method of claim 16, wherein receiving the location of the at least one of a plurality of pest traps is selected from at least one of: a user device associated with the user placing the pest traps, and a localization sensor attached to the at least one of a plurality of pest traps.

18. A method of deploying pest traps, comprising:
receiving by a processor, from one or more sensors configured to sense a presence of a pest in a plurality of pest traps, during a predetermined period of time indications related to pests trapped in the plurality of pest traps and the location of each pest trap;
receiving, by the processor, from one or more sensor for sensing environmental condition, during the predetermined period of time signals related to environmental conditions at the surroundings of the plurality of pest traps; and
determining, by the processor, pests expected behavior based on the received indications and signals.

19. The method of claim 18, further comprising:
providing, by the processor, recommended location for placing one or more pest traps based on the determining of expected behavior.
